(19) United States
(12) Patent Application Publication
(10) Pub. No.: US 2014/0112857 A1
(43) Pub. Date: Apr. 24, 2014

(54) SYSTEM FOR CAPTURING OF CO2 FROM PROCESS GAS

(71) Applicant: ALSTOM Technology Ltd, Baden (CH)

(72) Inventors: Michael Charles BALFE, Mainz (DE); Jonathan Lefebvre, Liancourt Saint Pierre (FR); Christoph Weingärtner, Gau-Algesheim (DE)

(73) Assignee: ALSTOM Technology Ltd, Baden (CH)

(21) Appl. No.: 14/056,486

(22) Filed: Oct. 17, 2013

(30) Foreign Application Priority Data
Oct. 17, 2012 (EP) 12188860.6

(51) Int. Cl. B01D 53/62; B01D 53/96

(52) U.S. Cl. CPC B01D 53/62; B01D 53/96
USPC 423/230; 423/637; 422/162

(57) ABSTRACT

The system includes a first reactor configured to discharge CO₂ depleted process gas. The first reactor having a first and a second portion of particulate sorbent material having captured CO₂. A second reactor is arranged to receive the first portion of particulate sorbent material and is configured to release CO₂ from the particulate sorbent material by decarbonation, return the first portion of particulate sorbent material to the first reactor, and discharge a CO₂ rich gas stream. A third reactor is arranged to receive the second portion of particulate sorbent material and is configured to supply water to the second portion of particulate sorbent material to hydrate at least a part of a remaining portion of calcium oxide of the second portion of particulate sorbent material to form calcium hydroxide, and return the second portion of particulate sorbent material to the first reactor.

### CROSS-REFERENCE TO RELATED APPLICATIONS

This application claims priority to European application 12188860.6 filed Oct. 17, 2012, the contents of which are hereby incorporated in its entirety.

### TECHNICAL FIELD

The present invention relates to a system for capturing of CO₂ from a process gas.

The present invention further relates to a method for capturing of CO₂ from a process gas.

### BACKGROUND

There is a general aim to capture the CO₂ in gases generated in power generation systems fuelled with for example fossil fuels, gas, or wood to make the process more environmentally friendly and to reduce the effect of global warming. The captured CO₂ gas may then be compressed and transported to be stored in a suitable place, for example in deep geological formations or deep ocean masses. There are several technologies known to remove CO₂ from the flue gas generated such as by absorption, adsorption, membrane separation, and cryogenic separation.

Dry processes for separation of carbon dioxide from gas mixtures may utilize metal oxides as sorbent. The metal oxide may form metal carbonate at high temperatures with carbon dioxide present. The carbon dioxide may be released from the metal carbonate under the reformation of the metal oxide. Problems associated with the use of metal oxides as adsorbents for carbon dioxide includes sintering of the adsorbents resulting in reducing the efficiency of the sorbents, and if sulfur is present in the gas, sulfur carbonate may be formed which may reduce the efficiency of the sorbents.

One dry process for separation of carbon dioxide from gas mixtures by use of a metal oxide sorbent is disclosed in WO 2009/148334 A1. The disclosed process incorporates regeneration of the carbon dioxide capture capacity of the metal oxide.

It is difficult to obtain efficient regeneration of sorbents for carbon dioxide capturing according to prior art.

### SUMMARY

Purposes of the present invention include providing solutions to problems identified with regard to prior art.

The present system and method allow for efficient capturing of CO₂ from a process gas with efficient regeneration of sorbent material able to capture the CO₂ present in process gas.

According to a first aspect of the present invention there is provided a system for capturing CO₂ from a process gas, the system comprising a first reactor arranged to receive a stream of process gas and a particulate sorbent material comprising calcium oxide able to capture the CO₂ present in the process gas such that calcium carbonate is formed, the first reactor comprising means for discharging CO₂ depleted process gas, a first portion of particulate sorbent material having captured CO₂, and a second portion of particulate sorbent material having captured CO₂; a second reactor arranged to receive the first portion of particulate sorbent material from the first reactor, the second reactor comprising heating means arranged to cause release of CO₂ from the particulate sorbent material by decarbonation of the calcium carbonate to form calcium oxide, the second reactor further comprising means for returning the first portion of particulate sorbent material to the first reactor and means for discharging a CO₂ rich gas stream; and a third reactor arranged to receive the second portion of particulate sorbent material from the first reactor, the third reactor comprising means for supplying H₂O to the second portion of particulate sorbent material to hydrate at least a part of a remaining portion of calcium oxide of the second portion of particulate sorbent material to form calcium hydroxide, the third reactor further comprising means for returning the second portion of particulate sorbent material to the first reactor.

To hydrate at least a part of a remaining portion of calcium oxide of the second portion of particulate sorbent material to form calcium hydroxide results in efficient regeneration of sorbent material. Hydration result in swelling of the sorbent material, thus hydration may act in removing from the sorbent material compounds, such as for example CaSO₄, which otherwise may block access to CaO of the sorbent material. The third reactor arranged to receive the second portion of particulate sorbent material from the first reactor results in efficient regeneration of sorbent material.

According to one embodiment, the first reactor may be a carbonator reactor, or a reactor where carbonization reactions may occur, the second reactor may be a calciner reactor, or a reactor where calcination reactions may occur, and the third reactor may be a hydrator reactor, or a reactor where hydration reactions may occur.

According to one embodiment, the first reactor may be a circulating fluidized carbonator reactor, the second reactor may be a circulating fluidized calciner reactor, and the third reactor may be a hydrator reactor.

According to one embodiment, the process gas may be flue gas. The flue gas may, for example, be from the combustion of coal, oil, natural gas, industrial and domestic waste and peat, for example in power plants.

According to one embodiment, the third reactor may be arranged to operate at a lower temperature than the first reactor, and the second reactor may be arranged to operate at a higher temperature than the first reactor.

According to one embodiment, the system may further comprise means for cooling the second portion of the particulate sorbent material prior to entering the third reactor.

According to one embodiment, the system may further comprise means for heating the second portion of the particulate sorbent material prior to returning to the first reactor.

According to one embodiment, the system may further comprise means for cooling the first portion of particulate sorbent material to be returned from the second reactor to the first reactor.

According to one embodiment, the system may further comprise means for heating the first portion of particulate sorbent material to be received by the second reactor from the first reactor.

According to one embodiment, the system may further comprise: means for cooling the second portion of the particulate sorbent material prior to entering the third reactor; and/or means for heating the second portion of the particulate sorbent material prior to returning to the first reactor, and/or means for cooling the first portion of particulate sorbent material to be returned from the second reactor to the first reactor, and/or means for heating the first portion of particulate sorbent material to be received by the second reactor from the first reactor.

According to one embodiment, the means for cooling the first portion of particulate sorbent material to be returned from the second reactor to the first reactor, and the means for heating the first portion of particulate sorbent material to be received by the second reactor from the first reactor, may be means for exchanging heat from the first portion of particulate sorbent material to be returned from the second reactor to the first reactor, to the first portion of particulate sorbent material to be received by the second reactor from the first reactor.

According to one embodiment, the third reactor may be arranged with means for feeding of H₂O into the third reactor. According to one embodiment, the means for feeding of H₂O into the third reactor, may be means for feeding of gaseous H₂O into the third reactor.

According to one embodiment, the system may further comprise a fourth reactor arranged to receive finer particulate sorbent material, the fourth reactor being arranged for agglomerating the finer particulate sorbent material into larger particulate sorbent material, and/or hydrating the sorbent material.

According to one embodiment, the fourth reactor may be arranged with means for feeding liquid comprising H₂O into the third reactor. According to one embodiment, the liquid comprising H₂O may further comprise additives, preferably viscosity modifying additives. According to one embodiment the fourth reactor may be a hydrator reactor arranged for agglomeration of particulate sorbent material.

According to one embodiment, the fourth reactor may be an agglomerator or a pelletizer.

According to one embodiment, the means for discharging CO₂ depleted process gas from the first reactor may comprise at least one particulate separator arranged to separate at least a portion of the second portion of particulate sorbent material from the CO₂ depleted process gas, and/or wherein the means for discharging CO₂ rich gas from the second reactor may comprise at least one particulate separator arranged to separate particulate sorbent material from the CO₂ rich gas, wherein the system further may comprise a fourth reactor arranged to receive at least a portion of the separated particulate sorbent material from the CO₂ depleted process gas and/or from the CO₂ rich gas, and agglomerate the separated particulate sorbent material into particulate sorbent material agglomerates, and means for transferring the agglomerates to the third reactor, and/or means for transferring the agglomerates to the first reactor.

According to one embodiment, the at least one particulate separator arranged to separate at least a portion of the second portion of particulate sorbent material from the CO₂ depleted process gas, may further be arranged to transfer heat to sorbent material entering the first reactor, and/or the at least one particulate separator arranged to separate particulate sorbent material from the CO₂ rich gas may further be arranged to transfer heat to sorbent material entering the second reactor.

According to one embodiment, the means for returning the second portion of particulate sorbent material to the first reactor may be arranged for dehydrating the hydrated calcium oxide, and/or wherein the first reactor may be arranged for dehydrating the hydrated calcium oxide.

According to a second aspect there is provided a method for capturing CO₂ from a process gas in a system comprising a first reactor, a second reactor and a third reactor, the method comprising the steps of: transporting process gas comprising CO₂ to the first reactor; contacting the process gas comprising CO₂ with a sorbent material comprising calcium oxide and carbonating a portion of the content of calcium oxide, such that sorbent material comprising calcium carbonate and calcium oxide is formed, in the first reactor; transporting a first portion of the sorbent material comprising calcium carbonate from the first reactor to the second reactor; releasing CO₂ from the first portion of the sorbent material comprising calcium carbonate and calcium oxide by decarbonation of at least a portion of the content of the calcium carbonate in the second reactor; returning, subsequent to the decarbonation, at least a portion of the first portion of the sorbent material from the second reactor to the first reactor; transporting a second portion of the sorbent material comprising calcium carbonate and calcium oxide from the first reactor to the third reactor; adding H₂O to the third reactor and hydrating at least a part of the second portion of the sorbent material comprising calcium carbonate and calcium oxide, to form calcium hydroxide from the calcium oxide; and returning, subsequent to the hydrating, the second portion of the sorbent material from the third reactor to the first reactor.

According to one embodiment of the second aspect, the method may further comprise the step of: dehydrating at least a part of the calcium hydroxide from the third reactor.

According to one embodiment of the second aspect, the dehydrating at least a part of the calcium hydroxide from the third reactor may occur by contacting the calcium hydroxide with CO₂ depleted flue gas discharged from the first reactor.

According to one embodiment of the second aspect, the method may further comprise the steps of: cooling the second portion of the sorbent material comprising calcium carbonate and calcium oxide prior to entering the third reactor; heating the second portion of the sorbent material comprising calcium carbonate and calcium hydroxide, prior to re-entering the first reactor, and, optionally; exchanging heat from the first portion of the sorbent material comprising calcium carbonate and calcium oxide transported towards the first reactor, to the first portion of the sorbent material comprising calcium carbonate and calcium oxide transported to the second reactor.

According to one embodiment of the second aspect, the method may further comprise the steps of: discharging CO₂ depleted process gas from the first reactor; separating particles from the discharged CO₂ depleted process gas from the first reactor; discharging CO₂ rich gas from the second reactor; separating particles from the discharged CO₂ rich gas from the second reactor; agglomerating at least a portion of the separated particles from the first reactor and/or the second reactor; and transferring at least a portion of agglomerates formed to the third reactor and/or to the first reactor.

According to one embodiment of the second aspect, the process gas may be flue gas.

According to one embodiment of the second aspect, the system may further comprise a fourth reactor, wherein the step of agglomerating takes place in the fourth reactor.

According to one embodiment of the second aspect, a step of hydration takes place in the fourth reactor in addition to the step of agglomerating.

According to one embodiment of the second aspect the step of agglomerating and/or hydration taking place in the fourth reactor may take place at a temperature of 100° C. or less.

According to one embodiment of the second aspect, the step of contacting the process gas comprising CO₂ with a sorbent material in the first reactor may take place at a temperature of 700° C. or less, the step of releasing CO₂ from the first portion of the sorbent material in the second reactor may take place at a temperature of at least 890° C., the step of hydrating at least a part of the second portion of the sorbent material in the third reactor may take place at a temperature of 510° C. or less.

According to a third aspect, there is provided a use of the system according to the first aspect, for regeneration of the particulate sorbent material.

Embodiments and discussions with regard to the first aspect may also be relevant with regard to the second and third aspects. References to these embodiments are hereby made, where relevant.

The above described aspects and other features are exemplified by the following figures and detailed description.

### BRIEF DESCRIPTION OF DRAWINGS

The invention is described in more detail below with reference to the appended drawings in which:

FIG. 1 is a schematic flow scheme of the system according to one embodiment of the invention.

FIG. 2 is a schematic flow scheme of the system according to one embodiment of the invention.

FIG. 3 is a schematic flow scheme of the system according to one embodiment of the invention.

FIG. 4 is a schematic flow scheme of the system according to one embodiment of the invention.

It is understood that the detailed description below is intended to improve the understanding of the invention, and should not be interpreted as limiting the scope of the invention.

### DETAILED DESCRIPTION

Reactions Taking Place in Embodiments:

The calcium oxide of the sorbent material may react with CO₂ under formation of calcium carbonate. When calcium oxide, CaO, and CO₂ is brought in contact, calcium carbonate, CaCO₃ may be formed according to carbonation reaction 1 (R1) under release of energy as heat. In the system of embodiments of the invention, R1 may take place, for example, in the first reactor, such as in the carbonator reactor.

CaO(s)+CO₂(g)⇄CaCO₃(s) R1

with ΔH_{r,298K}=−170 kJ/mol.

In the first reactor, R1 results in lowering of the CO₂ concentration in the process gas, such as flue gas, thus resulting in a gas effluent from the first reactor having a considerable lower concentration of CO₂ than the inlet concentration. In the case with flue gas, the concentration of CO₂ before capturing or reaction according to reaction (1), may be for example 15%. Reaction 1 may take place, for example, at or below 650° C., and at pressures of approximately 1 atmosphere, which may exist in the first reactor.

In addition to reacting with CO₂, CaO may react with sulfur dioxide, or SO₂, under formation of calcium sulfate and energy in the form of heat, according to reaction 2 (R2), for example if SO₂ is present in the process gas.

CaO(s)+SO₂(g)+1/2O₂(g)⇄CaSO₄(s) R2

with ΔH_{r,298K}=−520 kJ/mol.

R2 may, for example, take place in the calciner reactor. Particularly if in-situ oxyfired coal combustion takes place in the second reactor R2 may take place in the calciner reactor.

In addition SO₂ may react with CaCO₃ under formation of calcium sulfate and energy in the form of heat, according to reaction 3 (R3).

CaCO₃(s)+SO₂(g)+1/2O₂(g)⇄CaSO₄(s)+CO₂(g) R3

with ΔH_{r,298K}=−324 kJ/mol.

R3 may, for example, take place in the calciner reactor where partial pressures of CO₂ are expected.

CaO may react with water in a hydration reaction taking place in the third reactor, such as a hydrator reactor, according to reaction 4 (R4).

CaO(s)+H₂O(g)⇄Ca(OH)₂(s) R4

with ΔH_{r,298K}=−109 kJ/mol.

The reversed R4 describes dehydration of Ca(OH)₂, an endothermic reaction. Dehydration may efficiently be performed, for example, at conditions of atmospheric pressure, at a partial pressure of water at 0.1 atm, and at temperatures above approximately 400° C., such as above 410° C. Thus, dehydration may take place in the first reactor, such as the carbonator reactor, and/or in pipings and/or solids separation devices, such as for example cyclones, of the system comprising hot flue gas downstream the first reactor.

Reactions with sulphur dioxide, for example as described by R2 and R3, have a negative effect on the capacity of the sorbent material for capturing CO₂. Reactions according to R2 and R3, may occur if sulphur dioxide is present in the process gas, for example in the case of the process gas being flue gas for example resulting from burning of fuels such as coal, or other sulphur containing fuels. CaSO₄ may result in blockage of pores in the sorbent material, thus reducing the efficiency of CO₂ capturing by the sorbent material, for example due to blocking of the CaO present in the core of the sorbent particles. Further, a layer of CaCO₃ formed on the sorbent material particles reduces the efficiency of the sorbent material in capturing CO₂. Sintering of sorbent material which may occur also reduces the efficiency of the sorbent material in capturing CO₂. Since H₂O is a small molecule it is capable of penetrating product layers of CaSO₄ and/or CaCO₃ forming Ca(OH)₂ in less accessible regions of the particle. The molar volume of Ca(OH)₂ is larger than the molar volume for CaO. Thus, particles comprising CaO may swell when hydrated according to R4, resulting in crack formations in any present layer of CaSO₄ and/or CaCO₃, thus hydration according to R4 may improve the efficiency of the sorbent material and regenerate the sorbent material. Thus, the system according to embodiments are efficient for capturing of CO₂ from process gas such as flue gas, which may contain sulphur.

The third reactor, such as for example a hydrator reactor, arranged to hydrate solid material received from the first reactor and recycle hydrated solid material to the first reactor is an efficient way of increasing surface area of the sorbent material.

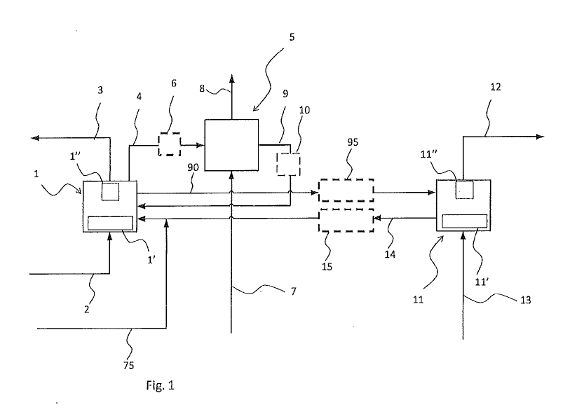

With reference to FIG. 1, a system for capturing CO₂ from flue gas which may or may not comprise sulfur, is described. The system comprises a carbonator arrangement 1, receiving flue gas via piping 2. The carbonator arrangement 1 comprises a circulating fluidized bed carbonator reactor 1′ optionally with internal heat transfer area in addition to solids separation device 1″ removing solids from the gas stream before the gas stream leaves the system through piping 3. The circulating fluidized bed carbonator reactor 1′ contains particulate sorbent material, in this particular example the sorbent material essentially consists of CaO. The sorbent reacts with CO₂ and CO₂ depleted flue gas leaves the carbonator reaction system 1 via piping 3, having undergone bulk solids removal.

Reacted sorbent is regenerated by decarbonation in the calciner arrangement 11 forwarded from the carbonator arrangement 1 by piping 90, which regeneration process can be described by endothermic reversed R1. The calciner arrangement 11 comprises a circulating fluidized bed calciner reactor 11′ with solids separation device 11″ removing solids in the gas stream before the gas stream leaves the system via piping 12. Thus, in the calciner arrangement 11, CaCO₃ is converted to CaO and CO₂, and CO₂ exits the calciner arrangement 11 by means of piping 12, having undergone bulk solids removal. Means for energy input into the calciner arrangement 11 is indicated by piping 13, which forwards for example a carbon source, such as coal, and an oxygen stream, such as oxygen diluted with CO₂. Sorbent, predominantly in the form of CaO particles exits the calciner arrangement 11 by means of piping 14 and is recycled to the carbonator arrangement 1. Optionally, a heat exchanger 15 is used to reduce the temperature of sorbent being recycled back to the first reactor. Optionally, a heat exchanger 95 is used to heat sorbent before entering the calciner arrangement 11. As an additional option these two heat exchangers may be combined so that heat is transferred from heat exchanger 15 to heat exchanger 95. Sorbent make-up flow, for example in the form of limestone, may be added through piping 75 to the stream of sorbent being recycled back to the carbonator arrangement 1 from the calciner arrangement 11.

The sorbent may be detoriated by sulfatization if sulfur is present in the flue gas, for example if the flue gas is resulting from burning of coal, as described by R2 and R3, and/or by sintering, for example during calcination. Sorbent particles, comprising CaCO₃, CaO, and possible CaSO₄, leave the carbonator arrangement 1 via piping 4 and enter hydrator reactor 5. The hydrator reactor 5 is equipped with heat transfer surface so that heat released during the hydration reaction can be removed from the hydrator reactor 5. Optionally, the sorbent particles may in addition or alternatively be cooled before entering the hydrator reactor 5, such as by means of optional heat exchanger 6. Reactivation medium comprising gaseous H₂O is fed to the hydrator reactor 5 via piping 7. Inside the hydrator reactor the sorbent is reacting according to R4 such that CaO is transferred to Ca(OH)₂. Under this reaction sorbent particles are regenerated. Possible excess gas, such as steam may leave the hydrator reactor by means of piping 8 or may be returned to carbonator arrangement 1. Regenerated sorbent particles are transferred back to the carbonator arrangement 1 via piping 9. Optionally, hydrated sorbent particles will be heated and dehydrated before entering the carbonator arrangement 1, such as by means of optional heat exchanger 10.

It will be understood that in addition to any heat exchangers discussed, heat may be removed from for example the carbonator arrangement 1 and the hydrator reactor 5 by suitable means.

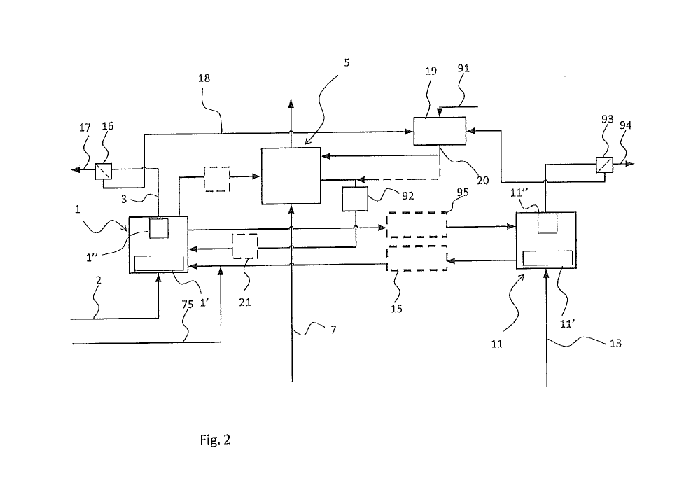

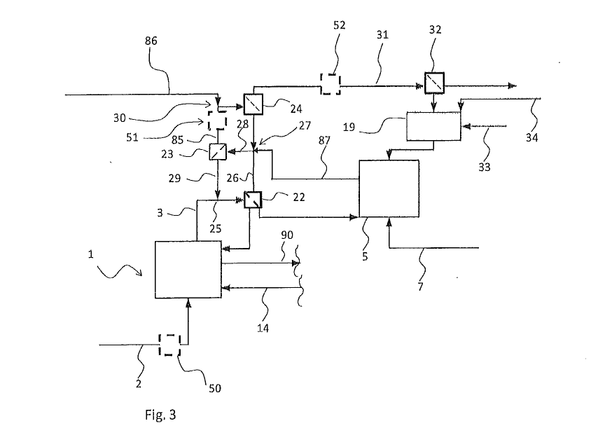

With reference to FIG. 2, a system is illustrated which in addition to what is described with reference to the system of FIG. 1, discloses means for pelletizing fine sorbent particles into a size suitable for the system. Particulate sorbent hydration may act, in conjunction with a number of particle size reduction mechanisms, to reduce the average particle size of the circulating particulate sorbent material by producing fine material what is hereafter referred to as fines. Re-processing of fine material or fines into larger particles decouples sorbent fines losses from process make-up requirements increasing sorbent utilization and reducing operational costs. The fines may be agglomerated to particles of a suitable size by means of the pelletizer 19. CO₂ depleted flue gas leaves the carbonator arrangement 1 through piping 3 containing a residue of particulate sorbent material, having undergone solids separation, and enters a sorting device 16 such as for example an electrostatic precipitator or bag filter, which removes most of the residual solids particulate material, such as fine sorbent particles, or fines, from the CO₂ depleted flue gas. Flue gas leaves the sorting device 16 by means of piping 17, while the particles leaves the sorting device 16 through piping 18, and enters the pelletizer 19. In addition, fines may be fed to the pelletizer 19 from the calciner arrangement 11 and separator 93, particularly for example in the case where ash free or indirect heating method is used to bring heat into the calciner arrangement 11. In the pelletizer 19 the fines are mixed with a liquid such as water or a mixture of water and binding agent fed from piping 91, resulting in wet agglomerates of the fine sorbent particles. Thus, agglomeration takes place inside the pelletizer 19. The agglomerates leave the pelletizer 19 by means of piping 20. The agglomerates may either be forwarded to the hydrator reactor 5, or to the carbonator arrangement 1. Since the hydration reaction in hydrator reactor 5 takes place at a higher temperature and requires water, the agglomerates may be forwarded and introduced into the hydrator reactor 5 where any water from the agglomerates will provide water for the hydration reaction. Thus, fine sorbent particles may be converted to larger sorbent particles. In addition to agglomeration taking place inside the pelletizer 19, or agglomerator, hydration may take place in the pelletizer 19. Thus, pelletizer 19 may function as a hydrator. It is realized that the pelletizer may be positioned elsewhere in a system than what is described in FIG. 3, and that pelletizer 19 in addition to receiving fines from separators 16 and 93, may receive fines from other suitable sources. The embodiment with reference to FIG. 2 may also comprise a calciner arrangement 11 as previously described from which calciner arrangement 11 CO₂ rich gas is discharged via residual dust separator 93 and piping 94.

With reference to FIG. 3, a carbonator reactor and pelletization system according to one embodiment is illustrated. The system illustrated in FIG. 3 comprises a plurality of gas-solids separators 22, 23, 24 which act in separating solids from gas and further act in heating solids while cooling gas, thus resulting in particles with a temperature suitable for the system while cooling the flue gas that is leaving the system, thus minimising energy input or heat transfer surface requirements. The separators 22, 23, 24 may, for example, be of cyclon type, or any other solids separator suitable for the purpose. Flue gas enters the carbonator reactor 1 through piping 2 where it optionally may be heated via heat exchanger 50. The carbonator reactor may be comprised of one or more sections in which the particulate sorbent material is contacted with CO₂ rich flue gas and may contain heat transfer surface to remove the heat released through reaction. A mixture of CO₂ depleted flue gas and sorbent particles leaves the carbonator reactor 1 at a temperature T1 through piping 3 and is forwarded to a point 25 where the gas and the sorbent particles are combined with a flow of sorbent particles from separator 23 at a lower temperature T2 and the combined flow is forwarded to separator 22. By means of separator 22, sorbent particles are separated from the gas and fines, which gas and fines are leaving the separator 22 via piping 26. Larger sorbent particles, having a temperature T3 between T1 and T2, are leaving the separator 22 and at least a part of the larger particles are forwarded to the hydrator reactor 5 in which hydration takes place as described above while at least a part of the sorbent particles are recycled back to the carbonator reactor 1. The gas and fines from separator 22, having a temperature T3 being between T1 and T2 are forwarded to a point 27 where they are combined with a flow of sorbent particles from separator 24 and with hydrated sorbent particles from the hydrator reactor 5, having temperatures T4 and T5 respectively both preferably lower than T3 before the combined flow is forwarded to separator 23 via pipe 28. It is realised that the flows may not be combined in the same point 27, but that one of the flows may enter downstream of the other flow, or vice versa. From the separator 23, sorbent particles are forwarded through piping 29 to point 25, as previously described at temperature T2, between T3 and T4 or T5, while gas and fines, at temperature T2, are forwarded through piping 85 to a connection point 30 where the fines and the gas is combined with a make-up flow comprising sorbent material from piping 86. A heat exchanger 51 may be positioned downstream separation device 23 to cool the flue gas stream before it is mixed with the cool sorbent make-up stream, the heat removed from heat exchanger 51 may optionally be coupled to the heating of flue gas in heat exchanger 50 so that heat flows from heat exchanger 51 to heat exchanger 50. The flow is forwarded to separator 24, from which sorbent particles, at temperature T4 lower than T2, are forwarded to point 27, as previously described while fines and gas are forwarded through piping 31, and leaving the system, for example towards a chimney (not illustrated). Before leaving the system, the gas and fines are optionally cooled in heat exchanger 52 before entering separator 32, separating the gas from fines, and forwarding fines to pelletizer 19. The pelletizer is fed liquid for agglomeration of the fines, such as water or water and binding agent through piping 33. In addition, the pelletizer 19 may be fed with fines from the calciner reactor 11, (not illustrated) through piping 34 if the operational mode restricts ash content from being too high. Agglomerated fines from the pelletizer are forwarded to hydrator reactor 5, wherein the agglomerated fines are transformed into dry sorbent particles under release of free water. The hydrator reactor 5 is fed liquid comprising water through piping 7. Piping 90 feed sorbent material from the carbonator reactor 1 towards the calciner system 11 (not illustrated) and piping 14 from the calciner reaction system 11 to carbonator reactor 1.

The system described above with reference to FIG. 3, thus describes efficient transformation of heat from flue gas to sorbent particles, such that flue gas is cooled and sorbent particles are heated to a suitable temperature before the particles enters the carbonator reactor 1. The embodiment is suitable for systems utilizing primarily steam hydration at higher temperatures, such as a hydration temperature about 510° C. or less. For example, such a system and for hydrating around 20% of the sorbent stream, the following temperatures may, for example, apply: T1 being around 650° C., T2 being between 350 and 550° C., T3 being between 540 and 610° C., T4 being between 200 and 300° C. and T5 being between 300 and 510° C.

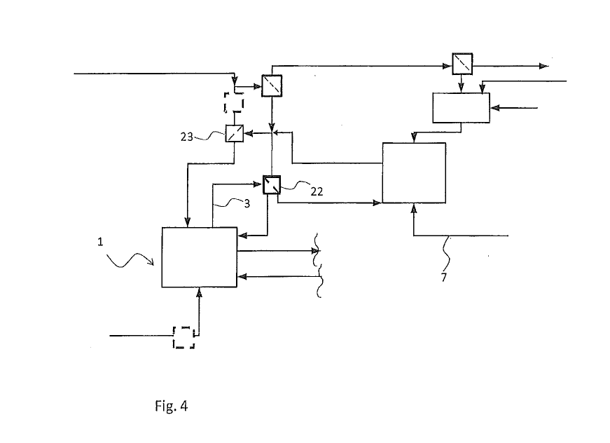

With reference to FIG. 4, an embodiment of the invention is illustrated. The embodiment only differs from the embodiment discussed with reference to FIG. 3 in that the stream of sorbent material from separator 23 is forwarded by means of piping directly into carbonator reactor 1 as an additional solids feed with the purpose of direct cooling and to improve the solids distribution and equilibrium driving forces in the upper section of the carbonation reactor. Thus, according to the embodiment illustrated by FIG. 4, the flow of sorbent material from separator 23 is not combined with a flow of gas and sorbent material from carbonator reactor 1 before entering the carbonator reactor 1. It is realised that the temperature of the sorbent material which is forwarded to the hydrator reactor 5 from separator 22 has a temperature essentially identical to the temperature of the sorbent material leaving the carbonator reactor 1 through pipings 3, for example around 650° C.

With regard to the embodiments, conditions for reactions R1 and R4, including for example temperatures and pressures, may be selected and/or maintained to favour desired reactants and/or products. Further the conditions may be selected to be suitable for the treated gas, the reactors and the system. Equilibrium pressures for gaseous reactants at different temperatures may be considered for selecting suitable conditions. For example, and with reference to R1, the fraction of CO₂ in flue gas may, for example, vary between 10 and 15 percent by volume for flue gas from power production and be as high as 30 percent by volume of CO₂ for flue gas from a conventional cement plant. For operating pressures of around 1 atm in the carbonator reactor, the temperature may be selected to be suitable for removal of 90% of the CO₂. For the case of power production, 650° C. is acceptable in order to reduce the concentration of CO₂ in the treated flue gas to 1 percent by volume. For example for the case of cement plants flue gas, increased temperatures would still allow a similar removal efficiency. Since diffusions processes proceed at an increased rate with increasing temperature, a staged temperature profile in the carbonation reactor may also be an advantage. According to one embodiment, the temperature of an upper section of the carbonator reactor may be below 650° C. and a lower section of the carbonator reactor above 650° C. It is realised that in analogy with the discussions above regarding suitable temperatures and pressures of the carbonator reactor, suitable conditions, such as for example temperatures and pressures, for other parts of the system, such as for example the calciner reactor and/or the hydrator reactor, or other parts, may be selected.

For example, CO₂ depleted flue gas having 10 percent by volume of water could be used to dehydrate sorbent around or slightly above 410° C. According to one embodiment the dehydration takes place above 410° C.

The position of the hydrator reactor 5 downstream of the carbonator reactor 1 according to the embodiments, such that sorbent material is forwarded to the hydrator reactor from the carbonator reactor without passing through the calciner reactor, results in efficient operating conditions for the hydrator reactor reducing the amount of cooling required for the material entering the hydrator reactor. For example, the temperature of the hydrator reactor may be maintained at or below 510° C., and the partial pressure of water may be selected at or below 1 atm.

Herein before it has been described that the carbonator reactor and the calcinator reactor are fluidized bed type of reactors, it is also appreciated that other types of carbonator reactors and calcinator reactors can be used.

To summarize, the present disclosure relates to a system for capturing CO₂ from a process gas. The system comprises a first reactor arranged to receive a stream of process gas and a particulate sorbent material comprising calcium oxide able to capture the CO₂ present in the process gas such that calcium carbonate is formed, the first reactor comprising means for discharging CO₂ depleted process gas, a first portion of particulate sorbent material having captured CO₂, and a second portion of particulate sorbent material having captured CO₂, a second reactor arranged to receive the first portion of particulate sorbent material from the first reactor, the second reactor comprising heating means arranged to cause release of CO₂ from the particulate sorbent material by decarbonation of the calcium carbonate to form calcium oxide, the second reactor further comprising means for returning the first portion of particulate sorbent material to the first reactor and means for discharging a CO₂ rich gas stream, and a third reactor arranged to receive the second portion of particulate sorbent material from the first reactor, the third reactor comprising means for supplying water to the second portion of particulate sorbent material to hydrate the calcium oxide to form calcium hydroxide, the third reactor further comprising means for returning the second portion of particulate sorbent material to the first reactor.

While the invention has been described and illustrated with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment described and illustrated herein as being the best mode contemplated for carrying out this invention, but that the invention will include all embodiments falling within the scope of the appended claims. Moreover, the use of the terms first, second, etc. are not intended to denote any order or importance, but rather the terms first, second, etc. are employed herein simply as a means of distinguishing one element from another.

1. A system for capturing CO₂ from a process gas, the system comprising
a first reactor arranged to receive a stream of process gas and a particulate sorbent material comprising calcium oxide able to capture the CO₂ present in the process gas such that calcium carbonate is formed, the first reactor comprising means for discharging CO₂ depleted process gas, a first portion of particulate sorbent material having captured CO₂, and a second portion of particulate sorbent material having captured CO₂,
a second reactor arranged to receive the first portion of particulate sorbent material from the first reactor, the second reactor comprising heating means arranged to cause release of CO₂ from the particulate sorbent material by decarbonation of the calcium carbonate to form calcium oxide, the second reactor further comprising means for returning the first portion of particulate sorbent material to the first reactor and means for discharging a CO₂ rich gas stream, and
a third reactor arranged to receive the second portion of particulate sorbent material from the first reactor, the third reactor comprising means for supplying water to the second portion of particulate sorbent material to hydrate at least a part of a remaining portion of calcium oxide of the second portion of particulate sorbent material to form calcium hydroxide, the third reactor further comprising means for returning the second portion of particulate sorbent material to the first reactor.

2. The system according to claim 1, wherein the first reactor is a carbonator reactor, the second reactor is a calciner reactor, and the third reactor is a hydrator reactor.

3. The system according to claim 1, wherein the third reactor is arranged to operate at a lower temperature than the first reactor, and the second reactor is arranged to operate at a higher temperature than the first reactor.

4. The system according to claim 1, the system further comprising:
means for cooling the second portion of the particulate sorbent material prior to entering the third reactor, and/or
means for heating the second portion of the particulate sorbent material prior to returning to the first reactor, and/or
means for cooling the first portion of particulate sorbent material to be returned from the second reactor to the first reactor, and/or
means for heating the first portion of particulate sorbent material to be received by the second reactor from the first reactor.

5. The system according to claim 4, wherein the means for cooling the first portion of particulate sorbent material to be returned from the second reactor to the first reactor, and the means for heating the first portion of particulate sorbent material to be received by the second reactor from the first reactor comprises means for exchanging heat from the first portion of particulate sorbent material to be returned from the second reactor to the first reactor, to the first portion of particulate sorbent material to be received by the second reactor from the first reactor.

6. The system according to claim 1, wherein
the means for discharging CO₂ depleted process gas from the first reactor comprises at least one particulate separator arranged to separate at least a portion of the second portion of particulate sorbent material from the CO₂ depleted process gas, and/or wherein
the means for discharging CO₂ rich gas from the second reactor comprises at least one particulate separator arranged to separate particulate sorbent material from the CO₂ rich gas, wherein the system further comprises a fourth reactor arranged to receive at least a portion of the separated particulate sorbent material from the CO₂ depleted process gas and/or from the CO₂ rich gas, and agglomerate the separated particulate sorbent material into particulate sorbent material agglomerates, and
means for transferring the agglomerates to the third reactor, and/or
means for transferring the agglomerates to the first reactor.

7. The system according to claim 1, wherein the process gas is flue gas.

8. The system according to claim 1, wherein the means for returning the second portion of particulate sorbent material to the first reactor is arranged for dehydrating the hydrated calcium oxide, and/or wherein the first reactor is arranged for dehydrating the hydrated calcium oxide.

9. A method for capturing CO₂ from a process gas in a system comprising a first reactor, a second reactor and a third reactor, the method comprising:
transporting process gas comprising CO₂ to the first reactor,
contacting the process gas comprising CO₂ with a sorbent material comprising calcium oxide and carbonating a portion of the content of calcium oxide, such that sorbent material comprising calcium carbonate and calcium oxide is formed, in the first reactor,
transporting a first portion of the sorbent material comprising calcium carbonate from the first reactor to the second reactor,
releasing CO₂ from the first portion of the sorbent material comprising calcium carbonate and calcium oxide by decarbonation of at least a portion of the content of the calcium carbonate in the second reactor,
returning, subsequent to the decarbonation, at least a portion of the first portion of the sorbent material from the second reactor to the first reactor,
transporting a second portion of the sorbent material comprising calcium carbonate and calcium oxide from the first reactor to the third reactor,
adding water to the third reactor and hydrating at least a part of the second portion of the sorbent material comprising calcium carbonate and calcium oxide, to form calcium hydroxide from the calcium oxide, and
returning, subsequent to the hydrating, the second portion of the sorbent material from the third reactor to the first reactor.

10. The method according to claim 9, further comprising:
dehydrating at least a part of the calcium hydroxide from the third reactor.

11. The method according to claim 9, further comprising:
cooling the second portion of the sorbent material comprising calcium carbonate and calcium oxide prior to entering the third reactor,
heating the second portion of the sorbent material comprising calcium carbonate and calcium hydroxide, prior to entering the first reactor, and, optionally,
exchanging heat from the first portion of the sorbent material comprising calcium carbonate and calcium oxide transported towards the first reactor, to the first portion of the sorbent material comprising calcium carbonate and calcium oxide transported to the second reactor.

12. The method according to claim 9, further comprising:
discharging CO₂ depleted process gas from the first reactor,
separating particles from the discharged CO₂ depleted process gas from the first reactor,
discharging CO₂ rich gas from the second reactor,
separating particles from the discharged CO₂ rich gas from the second reactor,
agglomerating at least a portion of the separated particles from the first reactor and/or the second reactor, and
transferring at least a portion of agglomerates formed to the third reactor and/or to the first reactor.

13. The method according to claim 12, wherein the system further comprises a fourth reactor, wherein agglomerating takes place in the fourth reactor.

14. The method according to claim 12, wherein agglomerating takes place at a temperature of 100° C. or less.

15. The method according to claim 9, wherein the process gas is flue gas.

16. The method according to claim 9, wherein
the step of contacting the process gas comprising CO₂ with a sorbent material in the first reactor takes place at a temperature of 700° C. or less,
the step of releasing CO₂ from the first portion of the sorbent material in the second reactor takes place at a temperature of at least 890° C.,
the step of hydrating at least a part of the second portion of the sorbent material in the third reactor takes place at a temperature of 510° C. or less.

17. A use of the system according to claim 1, for regeneration of the particulate sorbent material.
